(19) United States
(12) Patent Application Publication
(10) Pub. No.: US 2015/0022619 A1
(43) Pub. Date: Jan. 22, 2015

(54) SYSTEM AND METHOD FOR SHARING MULTIMEDIA CONTENT USING A TELEVISION RECEIVER DURING A VOICE CALL

(71) Applicant: WIT-SOFTWARE, CONSULTORIA E SOFTWARE PARA A INTERNET MÓVEL, S.A., Coimbra (PT)

(72) Inventors: Frederico Aleixo Dinis Lopes, Coimbra (PT); Nuno Emanuel Figueiredo Carvalho, Coimbra (PT); Luís Alexandre Serras De Moura E Silva, Condeixa-a-Nova (PT)

(73) Assignee: WIT-SOFTWARE, CONSULTORIA SOFTWARE PARA A INTERNET MÓVEL, S.A., Coimbra (PT)

(21) Appl. No.: 14/380,284

(22) PCT Filed: Feb. 21, 2013
(86) PCT No.: PCT/IB2013/051427

§ 371 Date: Aug. 21, 2014

(30) Foreign Application Priority Data
Feb. 21, 2012 (PT) 106172

(51) Int. Cl. H04N 7/14

(52) U.S. Cl. CPC H04N 7/147
USPC 348/14.02

(57) ABSTRACT

The disclosure comprises a method and system for exchanging multimedia content with a Television Receiver, during a voice call from a Multimedia Terminal to a Legacy Terminal, comprising previously associating the Television Receiver with the Legacy Terminal, storing said association a Television Application Server connected to the Television Receiver, and registering said association, within the same public identity, by a Communications Server connected to the Multimedia Terminal and to the Legacy Terminal; wherein the Communications Server exposes availability for establishing multimedia calls between the Multimedia Terminal and said public identity, in particular a Rich Communication Suite multimedia call availability.

When a multimedia IMS terminal establishes a voice call with a legacy terminal with no multimedia capabilities it loses the possibility to e.g. start a video call or a video sharing session regardless of the compliance with an IMS network. It is one object of to provide a solution to this.

### TECHNICAL FIELD

It is disclosed a system and a method for sharing multimedia content (i.e. video, images, pictures, maps, positioning coordinates, contacts, calendars, events and alike) during a multimedia call (e.g. RCS, Rich Communications Suite) from a multimedia-rich terminal to a legacy terminal with limited multimedia capabilities using a television receiver to receive or send the multimedia content other than voice. The method further includes the use of a Television receiver to display the multimedia content during the voice call with the legacy terminal.

### BACKGROUND ART

In the current status of the communications era, most people are connected through mobile devices. On the last few years there has been an increasing demand for more services and applications fueled by fast and cheaper internet connections provided by telecommunications operators.

These telecommunications operators are also the main driver behind the convergence of different types of communication such as Television, Landline, Mobile and Internet in a bundled service already available to millions of users around the world. This convergence opens new possibilities for multimedia rich scenarios beyond just voice. The Groupe Speciale Mobile Association (GSMA), Open Mobile Alliance (OMA) and Third Generation Partnership Project (3GPP) are pushing the standards and state of the art to bring such scenarios to fruition in what is called the Rich Communications Suite (RCS).

The 3GPP IP Multimedia Subsystem (IMS) Release 8 [1] standardizes methods for video call and video sharing between two mobile terminals [2][3][4]. Additionally, GSMA further specifies Video Sharing Interoperability [5] between two mobile terminals.

The RCS specifications delivers an experience beyond voice and SMS by providing consumers with instant messaging or chat, live video sharing and file transfer across any device, on any network, with anyone in their mobile address book. The RCS specifications are implemented on top of 3GPP IMS. Both the 3GPP IMS and RCS are heavily based on the SIP and SDP and protocol [7][8]. Also, [1] and [5] further details how the SIP and SDP are implemented in IMS and RCS.

However, such specifications require an IMS network and two mobile terminals with multimedia capabilities. When a mobile terminal or any multimedia terminal establishes a voice call with a legacy terminal with no multimedia capabilities it loses the possibility to start a video call or a video sharing session regardless of the compliance with an IMS network. It is one object of the present disclosure to provide a solution to this shortcoming.

### DISCLOSURE OF THE INVENTION

The disclosure comprises a method for exchanging multimedia content with a Television Receiver, during a voice call from a Multimedia Terminal to a Legacy Terminal, said Multimedia Terminal being able to exchange multimedia content, said method comprising:
previously associating the Television Receiver with the Legacy Terminal, storing said association in an Association Table at a Television Application Server connected to the Television Receiver, and registering said association, within the same public identity, by a Communications Server connected to the Multimedia Terminal and to the Legacy Terminal, said Communications Server being also connected to the Television Application Server;
the Communications Server exposing availability for establishing multimedia calls between the Multimedia Terminal and said public identity of the Legacy Terminal and associated Television Receiver, in particular a Rich Communication Suite multimedia call availability;
establishing a voice call between the Multimedia Terminal and the Legacy Terminal;
receiving, by the Television Application Server, of an user command to exchange multimedia content between the Multimedia Terminal and the Legacy Terminal, by way of the Television Receiver associated with the Legacy Terminal, said association having been previously stored in the Association Table of the Television Application Server;
indicating, by the Television Application Server, to the Communications Server, to establish a multimedia channel with the Multimedia Terminal;
establishing, by the Communications Server, of a multimedia channel between the Multimedia Terminal and the Television Receiver whose association was previously registered to the Legacy Terminal.

Some embodiments, for receiving multimedia content with the Television Receiver, in the step above of receiving, by the Television Application Server, of an user command, further comprise:
the Communications Server receiving a request from the user of the Multimedia Terminal to exchange multimedia content between the Multimedia Terminal and the Legacy Terminal;
the Communications Server identifying the Television Receiver whose association was previously registered to the Legacy Terminal;
the Communications Server notifying the Television Application Server corresponding to the identified Television Receiver of the multimedia exchange request;
the Television Application Server notifying the Television Receiver to display the request for multimedia exchange request;
the Television Application Server receiving, through the Television Receiver, of the acceptance by the Legacy Terminal user of the request for multimedia exchange request.

Some embodiments, in the steps above of the Television Application Server notifying the Television Application Server and the Television Application Server receiving the user acceptance, further comprise:
the Television Application Server notifying the Television Receiver to display the request for multimedia exchange request through a Notification Server that provides a display of the request, either interrupting or in overlay or side-by-side of the current video being displayed by the Television;
the Notification Server receiving, through the Television Receiver, of the acceptance by the Legacy Terminal user of the request for multimedia exchange request;
the Notification Server notifying the Television Application Server of the acceptance by the Legacy Terminal user of the request for multimedia exchange request.

Some embodiments, in the step of establishing, by the Communications Server, of a multimedia channel, further comprise:
the Communications Server establishing the routing of the multimedia channel between the Multimedia Terminal and the Television Receiver through a Multimedia Distribution Server, wherein the Multimedia Distribution Server is connected to the Television Application Server;
the Television Application Server indicating the Multimedia Distribution Server to relay the multimedia channel between the Multimedia Terminal and the Television Receiver.

Some embodiments comprise when the Television Receiver detects being powered-on:
notifying the Television Application Server of the power-on of the Television Receiver;
the Television Application Server consulting the Association Table for the Legacy Terminal associated with the Television Receiver;
the Television Application Server notifying the Communications Server to register said association;
the Communications Server registering said association.

Some embodiments comprise when the Television Application Server detects the Television Receiver being powered-off:
the Television Application Server consulting the Association Table for the Legacy Terminal associated with the Television Receiver;
the Television Application Server notifying the Communications Server to de-register said association;
the Communications Server de-registering said association;
the Communications Server no longer exposing availability for establishing multimedia calls between the Multimedia Terminal and said public identity of the Legacy Terminal and associated Television Receiver.

In some embodiments the voice call and the multimedia channel share the same connection between the Multimedia Terminal and the Communications Server.

In some embodiments:
if the voice call and the multimedia channel share the same connection between the Multimedia Terminal and the Communications Server, the multimedia channel is routed through the Communications Server; or
if otherwise, the multimedia channel is routed from the Multimedia Terminal to the Television Receiver through a Multimedia Distribution Server connected to the Television Receiver.

The disclosure comprises a system for exchanging multimedia content with a Television Receiver, during a voice call from a Multimedia Terminal to a Legacy Terminal, said Multimedia Terminal being able to exchange multimedia content, the system comprising:
a Television Application Server being configured to associate the Television Receiver with the Legacy Terminal, and to store said association in an Association Table, the Television Application Server being connected to the Television Receiver;
a Communications Server being configured to register said association, within the same public identity, the Communications Server being connected to the Multimedia Terminal and to the Legacy Terminal, said Communications Server being also connected to the Television Application Server;
the Communications Server being configured to expose availability for establishing multimedia calls between the Multimedia Terminal and the Legacy Terminal, in particular a Rich Communication Suite multimedia call availability;
the Television Application Server being configured to receive, during a voice call between the Terminal and the Legacy Terminal, of an user command to exchange multimedia content between the Multimedia Terminal and the Legacy Terminal, by way of the Television Receiver associated with the Legacy Terminal, said association having been previously stored in the Association Table of the Television Application Server;
the Television Application Server being configured to indicate to the Communications Server to establish a multimedia channel with the Multimedia Terminal when said user command is received;
the Communications Server being configured to establish a multimedia channel between the Multimedia Terminal and the Television Receiver whose association was previously registered to the Legacy Terminal, when said indication for the Television Application Server is received.

In some embodiments the system is further configured to carry out any one of the above methods.

Some embodiments comprises a computer readable medium comprising the computer program comprising computer program code adapted to perform any of the above methods when said program is run on a data processor.

### BRIEF DESCRIPTION OF DRAWINGS

The following figures provide preferred embodiments for illustrating the description and should not be seen as limiting the scope of the disclosure.

FIG. 1: Schematic representation of a first preferred embodiment for multimedia sharing to a TV receiver during a voice call.

FIG. 2: Schematic representation of method(s) for multimedia share during voice call in accordance with one or more embodiments.

FIG. 3: Schematic representation of method(s) of the functional blocks for multimedia share during voice call in accordance with one or more embodiments.

FIG. 4: Example notification for an authorization request to receive a video sharing

FIG. 5: Example video captured from the camera of a Multimedia Terminal to a TV Receiver.

FIG. 6: Schematic representation of method(s) for call interception between Household Terminal and Multimedia Sender

FIG. 7: Schematic representation of signaling, voice and direct multimedia channels.

FIG. 8: Schematic representation of signaling, voice and indirect multimedia channels.

### DETAILED DESCRIPTION

As already discussed, when a mobile terminal or any multimedia terminal establishes a voice call with a legacy terminal with no multimedia capabilities it loses the possibility to start a video call or a video sharing session regardless of the compliance with an IMS network.

It is provided a system and method to circumvent these limitations by enabling other devices, such as a TV receiver, to act as a multimedia terminal receiver on behalf of the legacy phone.

The object of this invention is to provide a system and a method for sharing multimedia content with a television receiver during an active voice call between a multimedia terminal and a legacy terminal with no multimedia capabilities, for example an household terminal (home phone). The multimedia terminal initiating the voice call can be any device like a mobile phone, tablet or Personal Computer that supports multimedia content sharing.

According to a first aspect, during a voice call between a multimedia terminal with internet access and a household terminal with no multimedia capabilities, the originator user is able to send multimedia content to be displayed on the television of the household.

For example, the mobile phone user is watching his son on a football match. The user can initiate a voice call to his mother home phone and then request a video share from the mobile's terminal camera video feed to the grandmother's TV allowing the grandmother to watch her grandson playing while still taking with her son in real-time.

In another example, the mobile phone user is stuck in traffic trying to reach a friend's house in time for dinner. The user can initiate a voice call to his friend and then request a GPS location share from his mobile's terminal to the friend's TV allowing the friend to track the user location on a map and redirecting him on an alternative route.

While features and concepts of the described system and methods for multimedia sharing to a TV receiver during a voice call can be implemented in any number of different environments, systems, and/or various configurations, embodiments for multimedia sharing to an associated TV receiver during a voice call are described in the context of the following example system and environments.

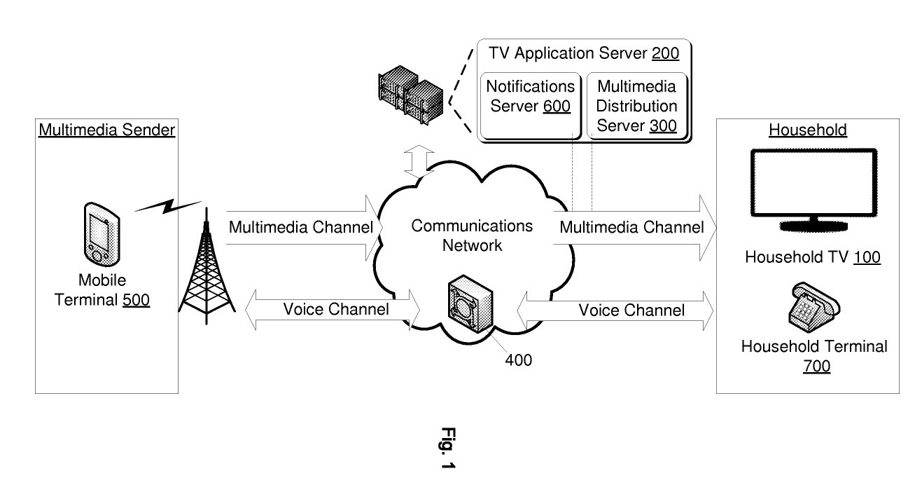

FIG. 1 illustrates an example system where a mobile multimedia terminal 500 establishes a voice call with a legacy phone 700 through a communications server 400 such as a mobile network operator server. The call setup follows the 3GPP standards included in [1][2][3][4]. Furthermore, the mobile multimedia terminal 500 requests a video sharing session with the TV receiver 100 located on the same household of the legacy phone 700 through a TV application server 200.

The household TV then displays a notification allowing the user of the legacy phone 700 to accept the video sharing request on the TV receiver 100 triggering the mobile multimedia terminal 500 camera's video feed to be sent to the TV receiver 100 through the Multimedia Distribution server 300 while maintaining the voice channel between the mobile multimedia terminal 500 and the legacy phone 700.

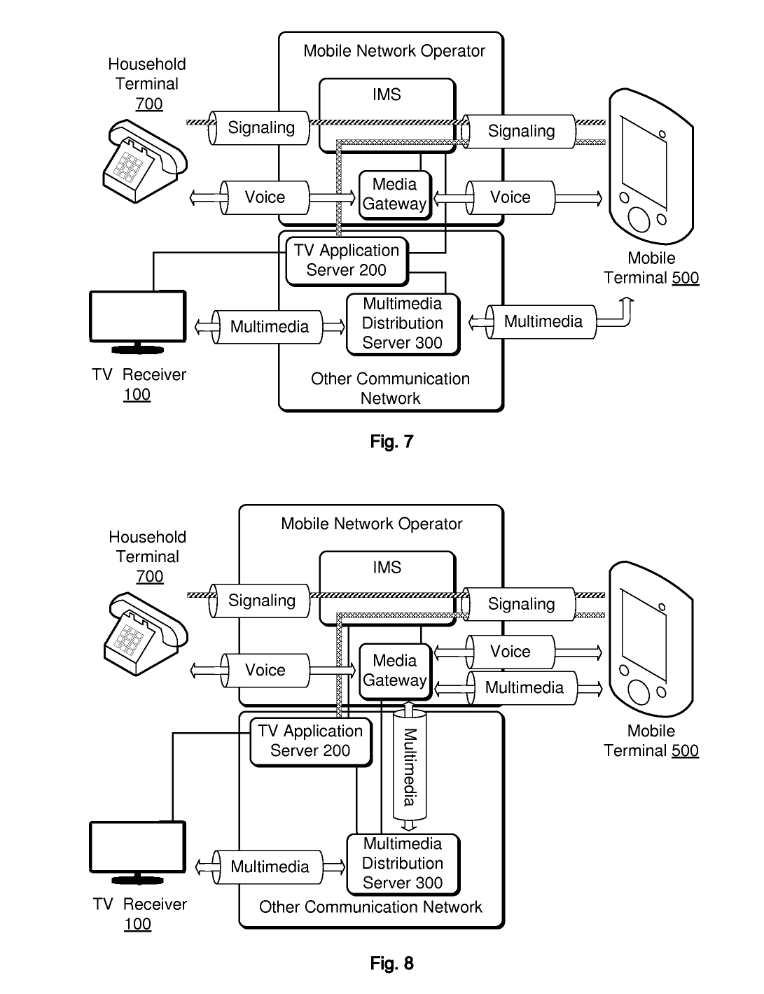

In one or more embodiments of the example system, the mobile phone can initiate image sharing, video sharing, location sharing while maintaining two separate media channel: voice channel and multimedia channel. During the call setup between the Household Terminal 700 and the Multimedia Sender 500 a voice channel is established allowing both endpoints to transmit and receive audio. For multimedia content (e.g. video) a different channel is setup and established to allow the Multimedia Sender 500 to send multimedia to the TV Receiver 100 as illustrated in the example FIG. 7 and in example FIG. 8.

FIG. 7 and FIG. 8 illustrates an embodiment where the different signaling, voice and multimedia channels are established upon voice session and multimedia session setup. On FIG. 7, the voice data is routed through the Media Gateway of the Mobile Network Operator while the multimedia data is routed through the Multimedia Distribution Server 300 deployed in communication network. A different method is illustrated on FIG. 8, where the voice data and multimedia data are routed to the Media Gateway of a Mobile Network Operator and then split. The voice channel is routed to the House Terminal 700 while the multimedia channel is routed to the Multimedia Distribution Server 200. On FIG. 7 and on FIG. 8 the signaling channel is used in the same way but is through signaling control data that the multimedia data can either be routed to the Media Gateway on the Mobile Network Operator or routed directly to the Multimedia Distribution Server 300.

The multimedia channel is requested by the Multimedia Sender 500 using SIP session setup [6] on what can be call Mobile Initiation Multimedia Channel. However, the TV receiver can also notify the TV Application Server to establish a multimedia channel to the Multimedia Sender 500 on what can be called Network Initiation Multimedia Channel where the TV Application Server behaves as second Multimedia Terminal but instructs the Multimedia Sender 500 to transmit multimedia to the Multimedia Distribution Server 300.

In some embodiments, the multimedia sharing can occur in the reverse direction, i.e. from a web camera or TV app through use of the TV receiver 100, to the mobile multimedia terminal 500. In some embodiments, the multimedia sharing is thus unidirectional, in either direction, but in other embodiments it may be bidirectional, when multimedia is exchanged simultaneously in both directions. In some embodiments, all directions are possible, depending on user preference, device capability, etc.

The illustrated example can be implemented in various embodiments that include more than one TV Application Server, more than one Multimedia Distribution Server and one or more Notification Server. The Servers can communicate to any number of various TV receivers or any number of various multimedia senders.

The communication network(s) and communication network(s) server(s) 400 includes any type of data network, voice network, broadcast network, an IP-based network, a wide area network (e.g. the Internet), and/or a wireless network that facilities data and/or voice communications between any number of various media terminals.

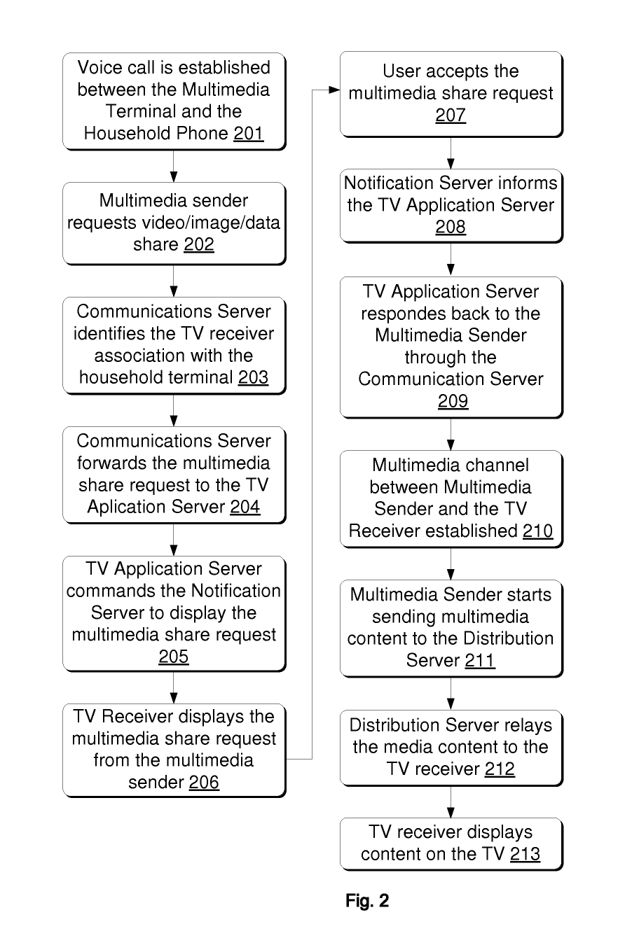

FIG. 2 illustrates example method(s) 215 for multimedia sharing to a TV receiver during a voice call and the order in which the method is described in not intended to be construed as a limitation, and any number of the described method blocks can be combined in any sensible order to implement the method, or an alternate method with the same result.

The method and system for multimedia sharing to a TV receiver during a voice call starts out from the status of the Multimedia Sender 500, or also referred as multimedia terminal, initiating a multimedia session while on voice call with the Household Terminal 700, or also referred as legacy terminal, as described in 201 and 202. While the voice call is routed through the telecommunications network, or also referred as communications network, to the Household Terminal 700, the multimedia session is established between the Multimedia Sender 500 and a Communications Server 400 through Session Initiation Protocol (SIP) and through Session Description Protocol (SDP) or any other session oriented transport protocol.

In some embodiments, the standardized SIP and SDP protocols provide an application-layer control (signaling) protocol for creating, modifying, and terminating sessions with one or more participants. These sessions include Internet telephone calls, multimedia distribution, and multimedia conferences. SIP invitations used to create sessions carry session descriptions through SDP that allow participants to negotiate on a set of compatible media types. SIP makes use of elements called proxy servers to help route requests to the user's current location, authenticate and authorize users for services, implement provider call-routing policies, and provide features to users. SIP also provides a registration function that allows users to upload their current locations for use by proxy servers such the Communications Server.

The Communications Server 400 is deployed in the household terminal telecommunications home domain or in any server with internet connectivity. Furthermore, both the TV Receiver 100, through the Application Server TV, and the Household Terminal 700 can be registered and authenticated within the Communications Server 400.

During the multimedia session negotiation, the Multimedia Sender 500 informs the Communications Server 400 regarding the destination number of the active call, thus enabling the Communications Server 400 to discover the TV Receiver 100 identification associated with the Household Terminal 700 as detailed on the summary below.

In some embodiments, the method for association between the Household Terminal 700 and the TV Receiver 200 can be implemented through call interception by the TV Application Server 200 between the Household Terminal 700 and the Multimedia Sender 500. Either terminal can initiate the voice call. The process begins by the TV Receiver 100 requests the TV Application Server 200 to initiate the interception of incoming calls to the Household Terminal 700. This can be originated at the startup process of the TV Receiver 100 as described in 601 or based on a user event from the TV Application Server 200. An example of such user event can be implemented through a configuration option on the TV or other device for the user to activate the multimedia sharing feature on the TV.

Furthermore, the TV Application Server 200 can be implemented by lookups services to provide information regarding the association between the TV Receiver 100 and the geographical landline number or, generically, the phone number of the Household Terminal 700. The lookup service can consult an association table where the association between both devices, the Household Terminal 700 and the TV Receiver 100 was provisioned manually. Alternatively, the lookup service can be implemented automatically by external sources. As an example of such external source, the TV Receiver 100 can be provisioned with the ASDL ID or Device ID which can be directly mapped to the number of the Household Terminal 700. The ADSL ID and Device ID are unique identifiers common on the telecommunications network operators systems.

Once there is a successful association between the TV Receiver 100 and the Household Terminal 700 as described in 602,603 then the TV Application Server 200 will request the Communications Server 400 to intercept the voice calls between the Household Terminal 700 and the Multimedia Sender 500 as described in 604. This can be implemented as an example using an IMS network as described in 605 where the TV Application Server 200 registers the correspondent geographical landline number or, generically, the phone number of the Household terminal 700 in the IMS network effectively exploring the IMS capabilities for identity sharing between different devices through the use of IP Multimedia Public Identities (IMPU).

When the TV Application Server 200 successfully registers the correspondent phone number of the Household Terminal 700, it is ready to act as a multimedia device to intercept voice calls and negotiate the multimedia content to be delivered on the TV Receiver 100 summarized in 203. As an example, the TV Application Server 200 can be implemented to act as a RCS client.

The TV Receiver 100, which is already registered and authenticated with the Communications Server (400) through the TV Application Server 200, then receives a request for multimedia sharing from the TV Application Server 200 through the Notifications Server 600 as described in 204 and 205. The request is then displayed on the Television, waiting for the household user to accept it as described in 206,

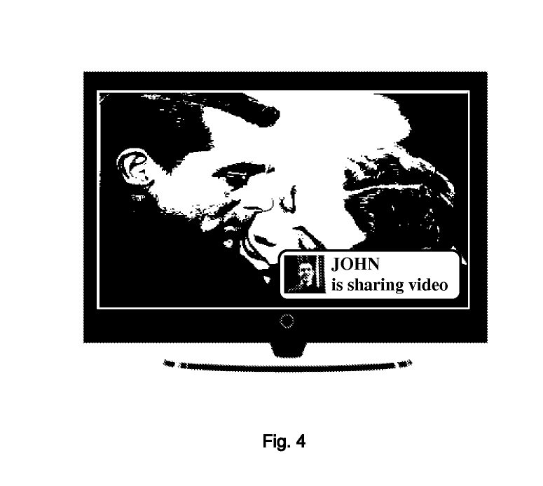

FIG. 4 illustrates an example visual notification on the Television whenever a voice call is initiated from the Multimedia Sender (e.g. mobile phone, laptop PC) to the Household Terminal (e.g. fixed telephone). This notification can be informative only (e.g. provide the contact information), but also allow the viewer to reject the call or reply with an SMS message, or any other feedback.

Once the multimedia request is accepted by the user as described in 207, the TV Receiver 100 sends the response back to the TV Application Server 200 as described in 208 that in turn forwards it to the Communications Server 400 until it reaches the Multimedia Sender 500 as described in 209.

In this point in stage, the Multimedia Sender 500 is ready to start sending multimedia content to the Multimedia Distribution Server 300 as described in 210 and 211. The Multimedia Distribution Server 300 relays the media content to the TV Receiver 100 that in turn displays the content on the TV as described in 212 and 213. The Multimedia Distribution Server 300 might need to change multimedia content in order to adapt it to the appropriate format supported by the TV Receiver 100.

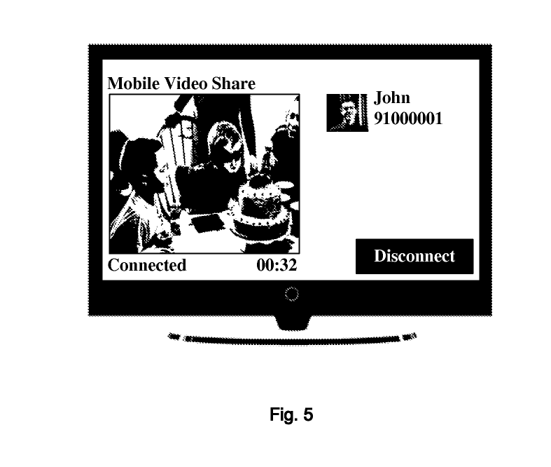

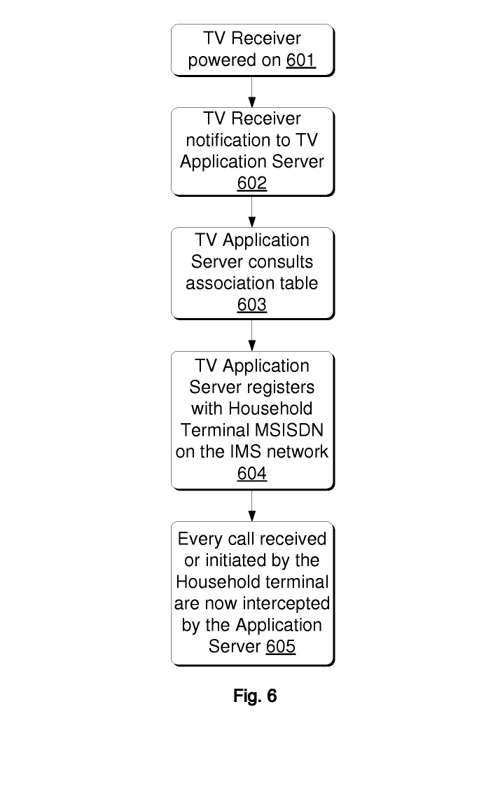

In some embodiments, sending multimedia content to the TV Receiver 100 can be further detailed through a process whereas once the user accepts an authorization request notification on the TV then a multimedia channel can be established between the Multimedia Server 500, or referred as the Multimedia Terminal, and the TV Receiver 100. The multimedia content, such as photos, videos and other media content, is delivered by the Multimedia Sender 500 to the Communications Server 400 which in turn relays the content to the TV Application Server 200. In turn, the TV Application Server 200 forwards the multimedia content to the Multimedia Distribution Server 300 that can adapt the receiving content to an appropriate format through transcoding, for example converting PNG to JPEG, or converting MP4 to MPEG2 or other combinations). The Multimedia Distribution Server 300 needs to know the characteristics of the TV Receiver 100 in order to generate the appropriate multimedia format to be sent to the TV Receiver 100. In the specific case of video content, the Multimedia Distribution Server 300 might need to do video transcoding in almost real-time. At this point, the Multimedia Distribution Server 300 informs the TV Application Server 200 regarding the location where the formatted content is available. The TV Application Server 200 then requests the Notification Server 600 to notify the TV Receiver 100 in order to launch the appropriate TV application and use the location containing the formatted content available from the Multimedia Distribution Server 300. As an example, FIG. 5 illustrates a TV application where the video feed from the camera of the Multimedia Sender 500 is being displayed on the TV.

Some embodiments implement a method for multimedia sharing to a TV receiver during a voice call where two separate channels are identified; i) a signaling channel for session setup and ii) a multimedia channel for media content such video stream, audio stream, images and other media content. Such example represents and out-of-band communication where call control information is in a separate channel from the data or voice stream and is a characteristic of the SIP and SDP protocols. However, this example can also be implemented using other protocols with in-band communication (signaling and data using the same channel), or any other in-band protocol.

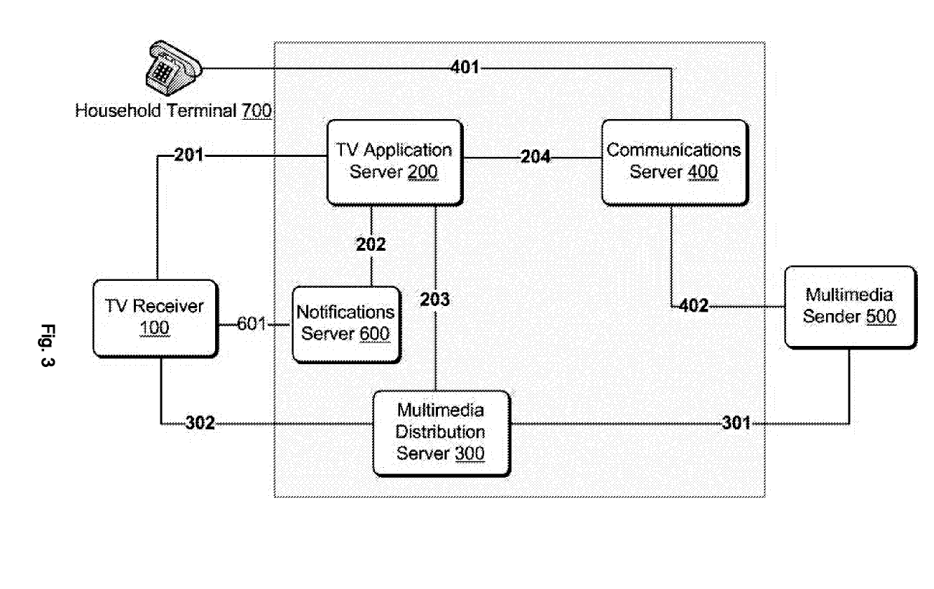

FIG. 3 shows a household terminal device 700 that is able to register with the Communications Server 400 in order to receive voice calls through an IP Network 401. This device might have limited capabilities for receiving multimedia content, such as voice capabilities only, or the user might prefer to receive multimedia content on the TV Receiver 100.

The registration process allows the Communication Server to identify the device's IP address (location), its status (on call or ready to receive calls), its capabilities and other information required to maintain and manage a media session.

All blocks of FIG. 3 are connected allowing request/responses, notifications, registrations and generic data to be exchange through a communication(s) network.

The Communications Server 400 is a device that receives the registrations requests over SIP protocol, or any other session oriented transport protocol from: (i) the Household Terminal Device 700, (ii) the Multimedia Sender 500 (iii) and the TV Receiver 100 through the TV Application Server 200. The TV Receiver (100) is associated with the household terminal device 700. Furthermore, the Communications Server 400 relays signaling and notifications between the TV Application Server (200) and the Multimedia Sender (500) also through SIP protocol or any other session oriented transport protocol.

The Multimedia Sender 500 is a device that registers with the Communications Server 400 and is able to share multimedia content.

The TV Receiver 100 is a device providing audio/video signals to the Television. This device can be detached from the Television through a wired/wireless connection or become integrated/built-in in the Television itself. This device uses an IP network 201; and it is able to run local and/or networked interactive applications that are sent by the Application Server 200, or also referred as TV Application Server. These interactive TV applications retrieve multimedia content (302), from the Multimedia Distribution Server 300, which is displayed on the Television. Multimedia content includes text, video, sound, images, pictures, maps, positioning, contacts, calendars, events and alike.

Regarding the 201 interface between the TV Application Server 200 and the TV Receiver 100, it carries the following types of data:
Application logic, either binary or text content (e.g. markup language like HTML-CE, MRML, HTML5), that is provided by the TV Application Server (200). Afterwards, it is processed and rendered by the TV Receiver 100.
Data Application which includes user-data related (e.g. photo from the user that is sharing multimedia content) and application-specific data such as the application's User Interface.
Application control commands/events with the following capabilities:
   Associate/de-associate the TV Receiver 100 to the Household Terminal 700 in order to have single-identity (same phone number for both). Once both devices are associated, the TV Receiver 100 is notified about incoming multimedia content. Notifications on TV Receiver 100 and Household Terminal (700) can occur approximately at the same time (simultaneous).
   Accept and reject the reception of multimedia content on the TV Receiver (100).
   Provides information about when multimedia content is available for consumption by the TV Receiver 100.

The Notifications Server 600 is responsible for informing the TV Receiver 100 that Multimedia Sender 500 requested to share multimedia content. The 601 interface carries the notification information about the incoming multimedia content. It can use a push and/or pull notification model.

Furthermore, the Notifications Server 600 can be implemented as a system that provides the capability to push messages to TV Receiver 100 but a polling method whereas the TV Receiver is periodically inquiring the 600 is also a valid alternative.

The 203 interface is used to handshake configurations (e.g. media format, IP port, capabilities, network resources, and all relevant information for multimedia data transmission) and allocate the appropriate resources on the Multimedia Distribution Server 300.

The Multimedia Distribution Server 300 is responsible for receiving the multimedia content from the Multimedia Sender (500) and delivering it to the TV Receiver 100 through the 302 interface. The Multimedia Distribution Server 300 might require adapting multimedia content to be correctly displayed on the TV Receiver 100. The content adaptation includes changes on containers, codec and delivery mode (i.e. transport). Additionally, it can also act as a proxy server for another Multimedia Distribution Server or any multimedia server.

The 302 interface delivers the multimedia content to the TV Receiver 100 taking into account the multimedia and network capabilities. This interface can use any multimedia transport like HTTP, HLS, RTP (and variations), RTMP (and variations), Microsoft Smooth Streaming or other transport protocols. The multimedia content formats, containers and codecs might be the following:
Text: plain-text (with or without encoding).
Image: JPEG, PNG, GIF, BMP.
Audio: WMA, AC-3, AAC, MPEG-1 L2, MPEG-1 L3, MPEG2 L1, MPEG2 L2.
Video: support for different containers and codecs such as:
   Containers: ASF, MP4, f-MP4, MPEG2 Transport Stream
   Codec: VC-1, WMV, H.264, VC1, MPEG2

The TV Application Server 200 and the Notifications Server 600 can be merged, depending on the underlying technology.

It is through the 204 interface that TV Receiver capabilities are negotiated with the Multimedia Sender 500 through the Communications Server 400 during the multimedia session setup. This interface also carries the response for multimedia sharing authorization request by the Multimedia Sender 500 and notifications about availability of the multimedia content ready to be sent from the Communications Server 400 to the TV Application Server (200). The preferred communication protocol for (204) interface is SIP but it can be any session oriented transport protocol.

While the invention has been illustrated and described in detail, they are to be considered illustrative or exemplary and not restrictive. In particular, the present invention covers further embodiments with any combinations of features from different embodiments described above.

### LIST OF REFERENCES (ALL INCORPORATED HEREIN BY REFERENCE)

[1] 3GPP TS 23.228, “IP Multimedia Subsystem (IMS); Stage 2”
[2] 3GPP TS 22.279, “Combined Circuit Switched (CS) and IP Multimedia Subsystem (IMS) sessions; Stage 1”
[3] 3GPP TS 23.279, “Combining Circuit Switched (CS) and IP Multimedia Subsystem (IMS) services; Stage 2”
[4] 3GPP TS 24.279, “Combining Circuit Switched (CS) and IP Multimedia Subsystem (IMS) services; Stage 3”
[5] GSM Association, “Video Share Phase 2 Interoperability Specification 2.2”, December 2010
[6] 3GPP TS 24.229, “IP multimedia call control protocol based on Session Initiation Protocol (SIP) and Session Description Protocol (SDP); Stage 3”
[7] The Internet Engineering Task Force (IETF), SIP: Session Initiation Protocol (RFC 3261)
[8] The Internet Engineering Task Force (IETF), SDP: Session Description Protocol (RFC 4566)

The embodiments described above are combinable. The following dependent claims set out particular embodiments of the invention.

1. A method for exchanging multimedia content with a Television Receiver, during a voice call from a Multimedia Terminal to a Legacy Terminal, said Multimedia Terminal being able to exchange multimedia content, comprising:
a. previously associating the Television Receiver with the Legacy Terminal, storing said association in an Association Table at a Television Application Server connected to the Television Receiver, and registering said association, within the same public identity, by a Communications Server connected to the Multimedia Terminal and to the Legacy Terminal, said Communications Server being also connected to the Television Application Server;
b. the Communications Server exposing availability for establishing multimedia calls between the Multimedia Terminal and said public identity of the Legacy Terminal and associated Television Receiver, in particular a Rich Communication Suite multimedia call availability;
c. establishing a voice call between the Multimedia Terminal and the Legacy Terminal;
d. receiving, by the Television Application Server, of an user command to exchange multimedia content between the Multimedia Terminal and the Legacy Terminal, by way of the Television Receiver associated with the Legacy Terminal, said association having been previously stored in the Association Table of the Television Application Server;
e. indicating, by the Television Application Server, to the Communications Server, to establish a multimedia channel with the Multimedia Terminal;
f. establishing, by the Communications Server, of a multimedia channel between the Multimedia Terminal and the Television Receiver whose association was previously registered to the Legacy Terminal.

2. A method according to claim 1, for receiving multimedia content with the Television Receiver further comprising in step d):
d1. the Communications Server receiving a request from the user of the Multimedia Terminal to exchange multimedia content between the Multimedia Terminal and the Legacy Terminal;
d2. the Communications Server identifying the Television Receiver whose association was previously registered to the Legacy Terminal;
d3. the Communications Server notifying the Television Application Server corresponding to the identified Television Receiver of the multimedia exchange request;
d4. the Television Application Server notifying the Television Receiver to display the request for multimedia exchange request;
d5. the Television Application Server receiving, through the Television Receiver, of the acceptance by the Legacy Terminal user of the request for multimedia exchange request.

3. A method according to claim 2, further comprising in steps d4/d5:
i. the Television Application Server notifying the Television Receiver to display the request for multimedia exchange request through a Notification Server that provides a display of the request, either interrupting or in overlay or side-by-side of the current video being displayed by the Television;
ii. the Notification Server receiving, through the Television Receiver, of the acceptance by the Legacy Terminal user of the request for multimedia exchange request;
iii. the Notification Server notifying the Television Application Server of the acceptance by the Legacy Terminal user of the request for multimedia exchange request.

4. A method according to claim 1, further comprising in step f):
f1. the Communications Server establishing the routing of the multimedia channel between the Multimedia Terminal and the Television Receiver through a Multimedia Distribution Server, wherein the Multimedia Distribution Server is connected to the Television Application Server;
f2. the Television Application Server indicating the Multimedia Distribution Server to relay the multimedia channel between the Multimedia Terminal and the Television Receiver.

5. A method according to claim 1, further comprising when the Television Receiver detects being powered-on:
i. notifying the Television Application Server of the power-on of the Television Receiver;
ii. the Television Application Server consulting the Association Table for the Legacy Terminal associated with the Television Receiver;
iii. the Television Application Server notifying the Communications Server to register said association;
iv. the Communications Server registering said association.

6. A method according to claim 1, further comprising when the Television Application Server detects the Television Receiver being powered-off:
i. the Television Application Server consulting the Association Table for the Legacy Terminal associated with the Television Receiver;
ii. the Television Application Server notifying the Communications Server to de-register said association;
iii. the Communications Server de-registering said association;
iv. the Communications Server no longer exposing availability for establishing multimedia calls between the Multimedia Terminal and said public identity of the Legacy Terminal and associated Television Receiver.

7. A method according to claim 1 wherein:
i. if the voice call and the multimedia channel share the same connection between the Multimedia Terminal and the Communications Server, the multimedia channel is routed through the Communications Server; or
ii. if otherwise, the multimedia channel is routed from the Multimedia Terminal to the Television Receiver through a Multimedia Distribution Server connected to the Television Receiver.

8. A method according to claim 1, wherein the voice call and the multimedia channel share the same connection between the Multimedia Terminal and the Communications Server.

9. A system for exchanging multimedia content with a Television Receiver, during a voice call from a Multimedia Terminal to a Legacy Terminal, said Multimedia Terminal being able to exchange multimedia content, comprising:
a. a Television Application Server being configured to associate the Television Receiver with the Legacy Terminal, and to store said association in an Association Table, the Television Application Server being connected to the Television Receiver;
b. a Communications Server being configured to register said association, within the same public identity, the Communications Server being connected to the Multimedia Terminal and to the Legacy Terminal, said Communications Server being also connected to the Television Application Server;
c. the Communications Server being configured to expose availability for establishing multimedia calls between the Multimedia Terminal and the Legacy Terminal, in particular a Rich Communication Suite multimedia call availability;
d. the Television Application Server being configured to receive, during a voice call between the Terminal and the Legacy Terminal, of an user command to exchange multimedia content between the Multimedia Terminal and the Legacy Terminal, by way of the Television Receiver associated with the Legacy Terminal, said association having been previously stored in the Association Table of the Television Application Server;
e. the Television Application Server being configured to indicate to the Communications Server to establish a multimedia channel with the Multimedia Terminal when said user command is received;
f. the Communications Server being configured to establish a multimedia channel between the Multimedia Terminal and the Television Receiver whose association was previously registered to the Legacy Terminal, when said indication for the Television Application Server is received.

10. A system according to claim 9, further configured to carry out a method for exchanging multimedia content with a Television Receiver, during a voice call from a Multimedia Terminal to a Legacy Terminal, said Multimedia Terminal being able to exchange multimedia content.

11. A computer readable medium comprising a computer program comprising computer program code adapted to perform the method of claim 1 when said program is run on a data processor.

12. A method according to claim 2, further comprising in step f)
f1. the Communications Server establishing the routing of the multimedia channel between the Multimedia Terminal and the Television Receiver through a Multimedia Distribution Server, wherein the Multimedia Distribution Server is connected to the Television Application Server;
f2. the Television Application Server indicating the Multimedia Distribution Server to relay the multimedia channel between the Multimedia Terminal and the Television Receiver.

13. A method according to claim 3, further comprising in step f):
f1. the Communications Server establishing the routing of the multimedia channel between the Multimedia Terminal and the Television Receiver through a Multimedia Distribution Server, wherein the Multimedia Distribution Server is connected to the Television Application Server;
f2. the Television Application Server indicating the Multimedia Distribution Server to relay the multimedia channel between the Multimedia Terminal and the Television Receiver.

14. A method according to claim 2, further comprising when the Television Receiver detects being powered-on:
i. notifying the Television Application Server of the power-on of the Television Receiver;
ii. the Television Application Server consulting the Association Table for the Legacy Terminal associated with the Television Receiver;
iii. the Television Application Server notifying the Communications Server to register said association;
iv. the Communications Server registering said association.

15. A method according to claim 3, further comprising when the Television Receiver detects being powered-on:
i. notifying the Television Application Server of the power-on of the Television Receiver;
ii. the Television Application Server consulting the Association Table for the Legacy Terminal associated with the Television Receiver;
iii. the Television Application Server notifying the Communications Server to register said association;
iv. the Communications Server registering said association.

16. A method according to claim 4, further comprising when the Television Receiver detects being powered-on:
i. notifying the Television Application Server of the power-on of the Television Receiver;
ii. the Television Application Server consulting the Association Table for the Legacy Terminal associated with the Television Receiver;
iii. the Television Application Server notifying the Communications Server to register said association;
iv. the Communications Server registering said association.

17. A method according to claim 2, further comprising when the Television Application Server detects the Television Receiver being powered-off:
i. the Television Application Server consulting the Association Table for the Legacy Terminal associated with the Television Receiver;
ii. the Television Application Server notifying the Communications Server to de-register said association;
iii. the Communications Server de-registering said association;
iv. the Communications Server no longer exposing availability for establishing multimedia calls between the Multimedia Terminal and said public identity of the Legacy Terminal and associated Television Receiver.

18. A method according to claim 3, further comprising when the Television Application Server detects the Television Receiver being powered-off:
i. the Television Application Server consulting the Association Table for the Legacy Terminal associated with the Television Receiver;
ii. the Television Application Server notifying the Communications Server to de-register said association;
iii. the Communications Server de-registering said association;
iv. the Communications Server no longer exposing availability for establishing multimedia calls between the Multimedia Terminal and said public identity of the Legacy Terminal and associated Television Receiver.

19. A method according to claim 4, further comprising when the Television Application Server detects the Television Receiver being powered-off:
i. the Television Application Server consulting the Association Table for the Legacy Terminal associated with the Television Receiver;
ii. the Television Application Server notifying the Communications Server to de-register said association;
iii. the Communications Server de-registering said association;
iv. the Communications Server no longer exposing availability for establishing multimedia calls between the Multimedia Terminal and said public identity of the Legacy Terminal and associated Television Receiver.

20. A method according to claim 5, further comprising when the Television Application Server detects the Television Receiver being powered-off:
i. the Television Application Server consulting the Association Table for the Legacy Terminal associated with the Television Receiver;
ii. the Television Application Server notifying the Communications Server to de-register said association;
iii. the Communications Server de-registering said association;
iv. the Communications Server no longer exposing availability for establishing multimedia calls between the Multimedia Terminal and said public identity of the Legacy Terminal and associated Television Receiver.
